(19) United States
(12) Patent Application Publication
(10) Pub. No.: US 2019/0337394 A1
(43) Pub. Date: Nov. 7, 2019

(54) VEHICLE EXPORTABLE POWER

(71) Applicant: BAE Systems Controls Inc., Endicott, NY (US)

(72) Inventors: Eugene M. Butash, Endwell, NY (US); Derek M. Matthews, Apalachin, NY (US); Filippo Muggeo, Endwell, NY (US)

(73) Assignee: BAE Systems Controls Inc., Endicott, NY (US)

(21) Appl. No.: 15/972,977

(22) Filed: May 7, 2018

(51) Int. Cl. B60L 11/18; B60W 20/15

(52) U.S. Cl. CPC B60L 11/1842; B60W 20/15; B60L 11/1861; B60K 6/46; B60W 2900/00; B60W 2560/02; B60W 2510/244; B60L 11/182

(57) ABSTRACT

Systems for exporting power from a vehicle with an engine are provided. Also provided is a multi-vehicle docking station having multiple connections for multiple vehicles to connect to and multiple power outputs, whereby vehicles may provide power to an external electrical load via the multi-vehicle docking station. One or more vehicles may provide export power to the load based on a remaining power capacity and fuel level in the vehicles.

### FIELD OF THE DISCLOSURE

This disclosure relates to powering electrical loads using a vehicle having an engine. More specifically, this disclosure relates to systems and methods for powering various electrical loads, such as a power grid from a vehicle.

### BACKGROUND

Power from electric utility grids is often not available during natural disasters. The absence of this power is often a critical problem because it can interrupt essential services such as police, fire and hospital.

Additionally, electric utility grids are not always available in all areas. One solution is to carry a portable generator. However, this creates logistical problems of transporting the generator and fuel for the generator.

### SUMMARY

Accordingly, disclosed is a power system for a vehicle. In an aspect of the disclosure, the power system comprises a first inverter, a second inverter, a switch and a processor. The first inverter is coupled to a generator. The generator is mechanically coupleable directly to a crankshaft of an engine. The first inverter, when the generator is coupled directly to the crankshaft of the engine, is configured to receive three-phase AC power from the generator when the engine is ON and provide DC power for a DC link. The second inverter is coupled to the DC link and configured to receive the DC power from the first inverter and provide three-phase AC power to a first power path and a second power path. The switch is configured to switch the provided three-phase AC power from the second inverter to one of the first power path and the second power path. The second power path supplies power to an external load. The processor is configured to control the switch and cause the three-phase AC power to be supplied to the external load or to the first power path at determined frequency and determined voltage. When the power is supplied to the external load, the determined frequency and the determined voltage meet power requirements for the external load.

In an aspect of the disclosure, the power system further comprises a connection interface. The connection interface is electrically coupled to the second power path. The connection interface has a sensor configured to detect a cable connected thereto. The sensor is in electrical communication with the processor. When the sensor detects the cable being connected to the connection interface, the sensor transmits a signal indicating a connection to the processor. The processor controls the switch to enable the three-phase AC power to be provided to the second power path.

In an aspect of the disclosure, the first power path may be coupled to an AC accessory. In another aspect of the disclosure, the first power path may be coupled to an AC propulsion motor for propelling the vehicle.

In an aspect of the disclosure, the vehicle may be a hybrid electric vehicle (HEV) having an energy storage device. The energy storage device is coupled to the DC link and may provide DC power to the same. The hybrid electric vehicle may be a series HEV.

In an aspect of the disclosure, the processor is configured to control the three-phase AC power received from the generator based on a state of charge (SOC) in the energy storage device, fuel for the engine and the power requirements of the external load. When the SOC of the energy storage device is above a preset threshold, power provided by the second inverter is supply from the energy storage device and the engine is OFF. When the SOC of the energy storage device is below or at the preset threshold, the processor causes the engine to start (if OFF) and receive fuel. Power to the external load is supplied by at least the generator.

In an aspect of the disclosure, the system further comprises at least one current sensor configured to sense a current drawn by the external load, and at least one voltage sensor. The processor is configured to control the three-phase AC power provided by the second inverter based on the sensed current and the sensed voltage.

In an aspect of the disclosure, the cable is coupleable to the external load via a filter and a transformer. The filter and/or transformer may be internal to the vehicle. In another aspect of the disclosure, the filter and/or transformer are external to the vehicle.

In an aspect of the disclosure, when the processor receives the signal indicating the connection of the cable to the connection interface, the processor is configured to cause the engine to automatically start.

In an aspect of the disclosure, the system further comprises a plurality of second inverters and a plurality of connection interfaces. Each second inverter is electrically coupled to the DC link. Each second inverter is configured to receive the DC power from the first inverter and provide the three-phase AC power. The power provided by each of the plurality of second inverters is different and specific to a type of load. Each connection interface is electrically coupled to the second power path. Each connection interface is different depending on the AC power output. Each connection interface has a sensor configured to detect a cable connected thereto. Each sensor is in electrical communication with the processor. When a sensor detects the cable being connected to a respective connection interface, the sensor transmits a signal indicating a connection to the processor. The processor is configured to control a corresponding one of the plurality of second inverters to provide the three-phase AC power to the second power path. When the corresponding one of the plurality of second inverters is the second inverter, the processor is configured to control the switch to switch between the first power path and the second power path.

Also disclosed is another power system for a vehicle. In an aspect of the disclosure, the power system comprises a first inverter and a DC-DC converter. The first inverter is coupled to a generator. The generator is mechanically coupleable to an engine. The first inverter, when the generator is coupled to the engine, is configured to receive three-phase AC power from the generator when the engine is ON and provide DC power for a DC link. The DC-DC converter is coupled to the DC link and configured to receive the DC power from the first inverter and converter the received DC power into another DC power level. The DC-DC converter is coupleable to another power converter. Another power converter is configured to provide single-phase AC power to an external load via a cable connected to a connection interface.

Also disclosed is a power system for a parallel hybrid electric vehicle. In an aspect of the disclosure, the power system comprises a first inverter, an energy storage device, a second inverter and a processor. The first inverter is coupled to a generator. The generator is mechanically coupleable directly to a crankshaft of an engine. The first inverter, when the generator is coupled directly to the crankshaft of the engine, is configured to receive three-phase AC power from the generator when the engine is ON and provide DC power for a DC link. The energy storage device is configured to provide DC power to the DC link. The second inverter is coupled to the DC link and the energy storage device and configured to receive the DC power from the DC link and provide three-phase AC power to an external load. The processor is configured to cause the three-phase AC power to be supplied to the external load when the external load is connected to a connection interface via a cable.

Also disclosed is a power system which comprises a plurality of vehicles and a vehicle docking station. The vehicle docking station comprises a plurality of docking ports, a wireless communication interface, a connection sensor and a processor. The vehicle docking station is coupleable to an external load. A vehicle with any of the above configurations may be a vehicle coupled to the vehicle docking station including a serial hybrid electric vehicle or a parallel hybrid electric vehicle.

Additionally, in an aspect of the disclosure, each vehicle comprises a power processor, a wireless communication interface and a connection interface. The connection interface is electrically coupleable to the vehicle docking station via a cable. The cable is coupleable to a respective docking port. When the vehicle is electrically coupled to the vehicle docking station via the cable in the docking port, the sensor in the vehicle docking station detects the coupling and transmits a signal indicating the coupling to the processor. When a plurality of vehicles are coupled to the vehicle docking station, a power processor of one of the vehicles is determined as a master processor. The master processor has a master load supply file. The master load supply file has a state of charge (SOC) of a respective energy storage device in each vehicle coupled to the vehicle docking station and a fuel level in each vehicle coupled to the vehicle docking station. Each vehicle wirelessly transmits the SOC and fuel level to the master processor. When one or more vehicles are coupled to the vehicle docking station and the vehicle docking station is coupled to the external load, power is supplied from the one or more vehicles to the external load based on a respective SOC and a respective fuel level.

In an aspect of the disclosure, when the fuel level of a vehicle is below a predetermined value, the power processor for the vehicle wirelessly transmits a signal to the master processor. In response to receipt of the signal, the master processor updates the master load supply file and transmits a permission to undock the vehicle from the vehicle docking station.

In an aspect of the disclosure, when the fuel level of the vehicle determined as the master processor is below a predetermined value, the master processor wirelessly transmits a signal to each of the plurality of vehicles and another of the plurality of vehicles becomes the master processor. A new master processor is selected by the master processor based on the SOC and the fuel level, respectively in each of the plurality of vehicles coupled to the vehicle docking station.

In an aspect of the disclosure, the master processor determines a remaining power capacity for supplying power to the external load for each vehicle coupled to the vehicle docking station based on the received SOC and the fuel level, compares the determined remaining power capacity with a preset threshold, and wirelessly transmits a warning to a respective vehicle when the remaining power capacity for the vehicle is lower than the preset threshold.

In an aspect of the disclosure, the initial master processor is the processor of the first vehicle coupled to the vehicle docking station. In another aspect of the disclosure, the processor in the vehicle docking station determines the initial master processor.

Also disclosed is a power system for a vehicle. In an aspect of the disclosure, the power system comprises a first inverter, a second inverter, a switch and a processor. The first inverter is coupled to a generator. The generator is mechanically coupleable to an engine. The first inverter, when the generator is coupled to the engine, is configured to receive three-phase AC power from the generator when the engine is ON and provide DC power for a DC link. The second inverter is coupled to the DC link and configured to receive the DC power from the first inverter and provide three-phase AC power to a first power path and a second power path. The switch is configured to switch the provided three-phase AC power from the second inverter to one of the first power path and the second power path. The first power path supplies power to an AC accessory and the second power path supplying power to an external load. The processor is configured to control the switch and cause the three-phase AC power to be supplied to the external load or to the AC accessory at determined frequency and determined voltage. When power is supplied to the external load, the determined frequency and the determined voltage meets power requirements for the external load.

### DRAWINGS

FIG. 1 illustrates a block diagram of exporting power from a series hybrid electric vehicle to an external load in accordance with aspects of the disclosure;

FIG. 2 illustrates a block diagram of exporting power from a series hybrid electric vehicle to an external load in accordance with other aspects of the disclosure;

FIG. 3 illustrates a block diagram of exporting power from a series hybrid electric vehicle to an external load in accordance with other aspects of the disclosure;

FIG. 4 illustrates a block diagram of exporting power from a series hybrid electric vehicle to an external load in accordance with other aspects of the disclosure;

FIG. 5 illustrates a block diagram of exporting power from a vehicle to an external load in accordance with aspects of the disclosure;

FIG. 6 illustrates a block diagram of exporting power from a vehicle to an external load in accordance with other aspects of the disclosure;

FIG. 7 illustrates a block diagram for exporting power from a parallel hybrid electric vehicle to an external load in accordance with aspects of the disclosure;

FIG. 8 illustrates a block diagram showing voltage and current sensors in an inverter in accordance with aspects of the disclosure;

FIG. 9 illustrates a block diagram of a multi-vehicle power system for exporting power to a load in accordance with aspects of the disclosure; and

FIG. 10 illustrates a block diagram of the multi-vehicle docking station in accordance with aspects of the disclosure.

### DETAILED DESCRIPTION

The disclosed power systems are capable of supplying power to an external load. The external load may be an electric utility grid such that grid power may be sustained during natural disasters. The power system is at least partially provided in a vehicle. The term vehicle used herein means a car, bus, taxi, vessel, airplane, train, tank, truck, or helicopter or any other moving apparatus propelled by an engine.

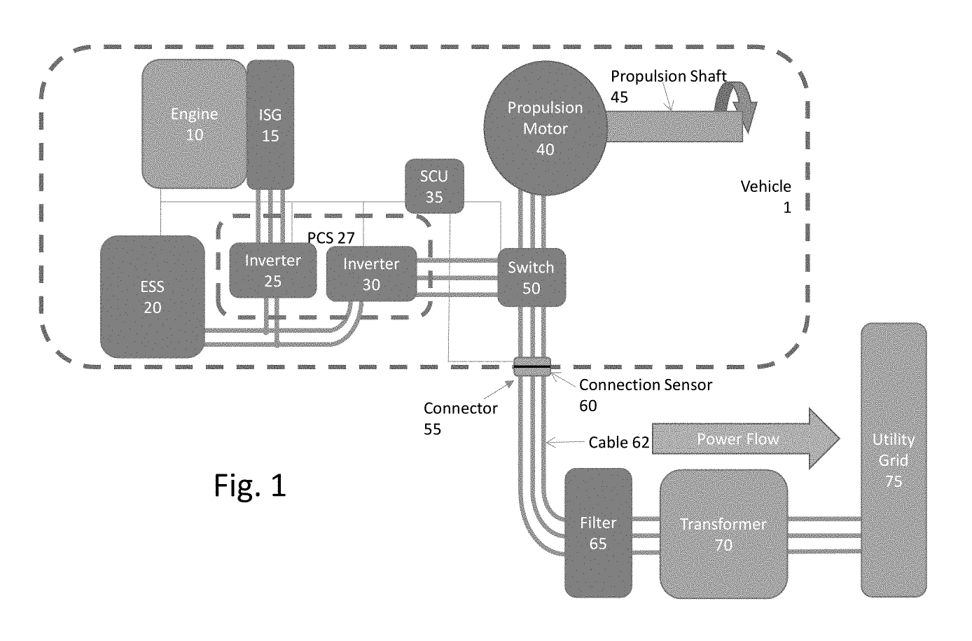

FIG. 1 illustrates a block diagram of a vehicle 1 in accordance with aspects of the disclosure. The vehicle 1 is configured as a series hybrid electric vehicle. The vehicle 1 comprises an engine 10. The engine 10 (e.g., a prime mover) may be an engine that uses gasoline, a diesel engine or a compressed natural gas (CNG) engine (collectively referred to herein as “fuel”). The engine 10 comprises a crankshaft (not shown in the figures). The crankshaft rotates.

The vehicle 1 also comprises an integrated-starter generator (“ISG”) 15. The ISG 15 comprises a movable shaft (also not shown in the figures). The movable shaft is directly coupled to or mounted to the engine crankshaft. Advantageously, by mounted the ISG 15 directly on the crankshaft, it eliminates a need for a Power-take-off device. Additionally, a crankshaft mounted generator (such as ISG 15) can be larger than a generator connected through an intermediary PTO, thereby enabling the generation of greater amounts of power to be exported. This is particularly useful when large amounts of power are often needed during natural disasters and during military deployment. Moreover, being able to generate greater amounts of power enables various different types of loads to be supported by the same vehicle. For example, vehicle 1 may be use to power electric devices, such as power tools, refrigerators, stoves, space heaters, and certain emergency equipment, but also may be used to supply power to a utility grid, a building or military base where power requirements are larger.

In the vehicle 1 depicted in FIG. 1, the same ISG 15 that normally supplies propulsion power for the vehicle 1 is used to supply power to an external load. In an aspect of the disclosure, the crankshaft mounted generator is capable of providing up to 230 Kw of 3 phase exportable power. The ability to generate and provide this range of exportable power eliminates the need to carry a separate generator. For example, a transit bus (an example of vehicle 1), may be used to supply exportable power to an utility grid (an example of a load) and building power (another example of a load) during natural disasters. Similarly, military vehicles (another example of vehicle 1) may provide exportable power to bases or situations where the National Guard is deployed, where needed. For example, instead of transporting trucks and dedicated generator-equipped trailers during deployment, the trailers can be eliminated to enable additional trucks with on-board generators to be transported within the same space. Moreover, since hybrid vehicles require less fuel for propulsion, fuel transportation cost is reduces and longer range can be achieved.

The ISG 15 may be a permanent magnet generator. Other generators may be used. When coupled to the engine 10 (referred to herein as the genset), the ISG 15 provides three-phase AC electrical power. The generator 15 may provide a variable frequency AC electrical power. The generator 15 is a high voltage generator.

The ISG 15 is electrically coupled to the propulsion control system (PCS) 27. The coupling is shown with three thick lines (verses a thin line). The PCS 27 provides for the power processing and conversion.

The PCS 27 comprises two inverters 25 and 30. Inverter 25 is coupled to the ISG 15 and receives the three-phase AC power therefrom. Since the inverter 25 is coupled to the ISG 15, the inverter is also referenced herein as the generator inverter. The generator inverter 25 converts the three-phase AC power into a DC voltage for a high voltage DC link. The high voltage DC link is shown in the figures as two thick lines connected to the generator inverter 25 and inverter 30 (as well as the energy storage system (ESS 20). High used herein means a voltage above 50V.

The ESS 20 provides a direct current (DC) electrical power to the same high voltage DC link. The ESS may include lithium ion batteries. In an aspect of the disclosure, the nominal voltage of the high voltage DC link is above 600V. The power from the ISG 15 (through the inverter 25), may also recharge the ESS 20.

The ESS 20 may also alternatively include ultra-capacitors, lead-acid batteries, and other energy storage mediums. The ultra-capacitor may include an electric double-layer capacitor (EDLC), also known as a, supercapacitor, supercondenser, or an electrochemical double layer capacitor, which has an electrochemical capacitor with relatively high energy density.

The inverter 30 is electrically connected to the ESS 20 and the inverter 25 via the high voltage DC link. The inverter 30 receives DC power from the inverter 25 and ESS 20 and provides a three-phase AC power. The three-phase AC power is shown in the figure as three thick lines connected to the inverter 30.

The vehicle 1 further comprises a system control unit (SCU) 35. The SCU communicates with various components of the vehicle over a control area network (CAN), shown in the figures as thin communication lines. For example, the SCU 35 communicates with both inverters 25 and 30, the ESS 20 and a controller in the engine (not shown in the figure).

The SCU 35 comprises a processor and a memory. Certain functionality of the processor will be described in detail later.

The processor may be a microcontroller or microprocessor or any other processing hardware such as a CPU or GPU. The memory may be separate from the processor (as or integrated in the same). For example, the microcontroller or microprocessor includes at least one data storage device, such as, but not limited to, RAM, ROM and persistent storage. In an aspect of the disclosure, the processor may be configured to execute one or more programs stored in a computer readable storage device. The computer readable storage device can be RAM, persistent storage or removable storage. A storage device is any piece of hardware that is capable of storing information, such as, for example without limitation, data, programs, instructions, program code, and/or other suitable information, either on a temporary basis and/or a permanent basis.

The SCU 35 in conjunction with the PCS 27 controls the amount of power exported to a load (e.g., utility grid 75) or to a propulsion motor 40.

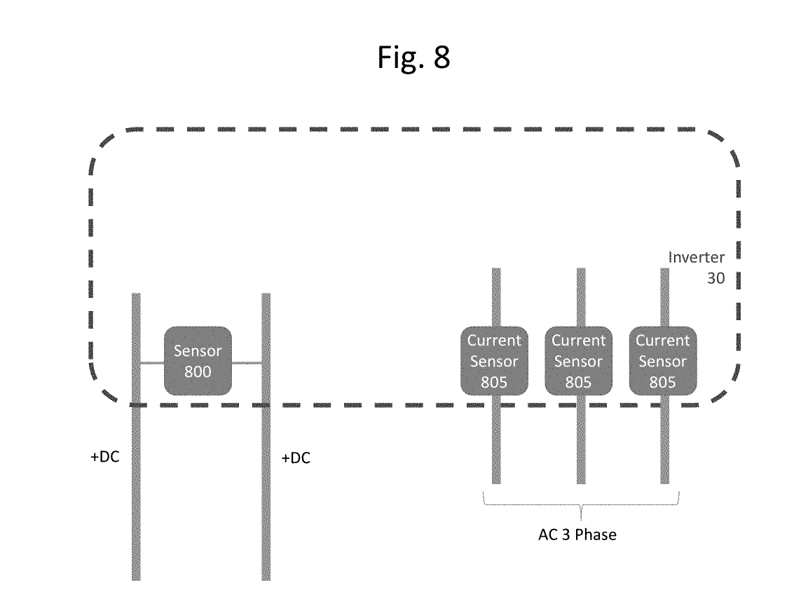

The term inverter used herein not only means circuitry for transforming DC into AC or vice versa, but also include control circuitry and programs for frequency determination and duty cycle calculations. The inverter also includes sensors. For example, as shown in FIG. 8, inverter 30 comprises voltage sensors 800 and current sensors 805. In an aspect of the disclosure, a voltage sensor detects a voltage of the high voltage DC link. In another aspect of the disclosure, voltage sensors 800 detect the voltage of each of the three-phases output from the inverter 30. Similarly, the current sensors 805 detect the current of each of the three-phases output from the inverter 30.

In an aspect of the disclosure, the SCU 35 controls the ISG 15 via the PCS 27.

The vehicle 1 further comprises a propulsion motor 40 and propulsion shaft 45. The propulsion motor 40 propels the vehicle 1 using the shaft 45. In an aspect of the disclosure, the propulsion motor may be an AC traction motor and used in any of the above described vehicles including marine.

The propulsion shaft 45 is directly or indirectly mechanically coupled to the vehicle axles and wheels.

The vehicle 1 further comprises a switch 50. In an aspect of the disclosure, the switch is three switches, one for each phase. The three switches are collectively referenced herein as “switch”. The switch 50 is connected between the inverter 30 and either the propulsion motor 40 or connector 55. The switch 50 switches the output power from the inverter 30 between the propulsion motor 40 to propel the vehicle 1 and the connector 55 for exporting power to a load, e.g., utility grid 75.

The SCU 35 controls the switch 50. In an aspect of the disclosure, the switch 50 is a relay (e.g., an electrically operated switch). In some aspects, the relay is a contactor (for high power applications). In an aspect of the disclosure, the switch 50 may be single pole-double throw (SPDT). In one state, the switch 50 may be closed toward the propulsion motor 50, electrically connecting the inverter 30 and the same (isolating the connector 55). In another state, the switch 50, may be closed toward the connector 55, electrically connecting the inverter 30 and the connector 55. While a SPDT device has been described herein other types of switching devices may be used such as a rotary device with two states. Additionally, as described above a single set of three switches, e.g., switch, may be used, two sets of three switches may also be used instead. One set between the inverter 30 and propulsion motor 40 and another set between the inverter 30 and connector 55. The sets would be complementary controlled.

In another aspect of the disclosure, a contactor may be used to control the states of all three phases (e.g., opened or closed). For example, one contactor may be used between the inverter 30 and propulsion motor 40 (controlling the three phases) and another contactor may be used between the inverter 30 and connector 55 (controlling the three phases). The contactors would be complementary controlled.

In other aspects of the disclosure, the switches may be semiconductor based, such as a MOSFET. In other aspects of the disclosure, a mechanically operated switch may be used.

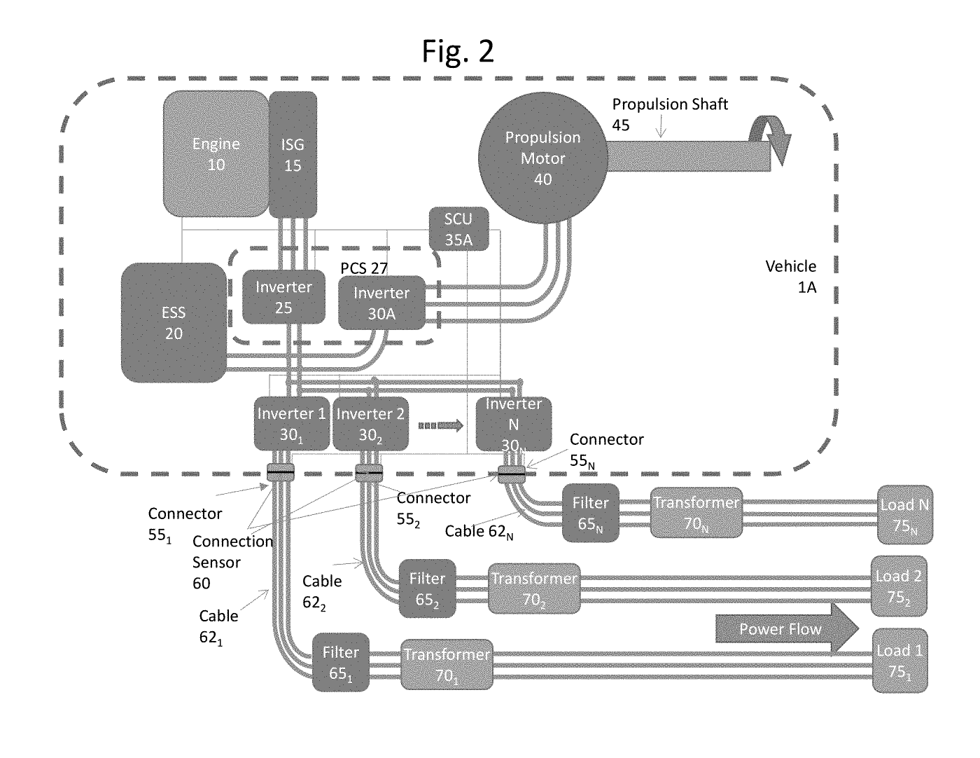

The connector 55 of the vehicle 1 serves as a connection interface, e.g., jack, for a connection cable 62 to be inserted or connected thereto. The connector configuration of the connector is related to the load. A different type of load may have a different connector 55 which is needed. As shown in FIG. 2, the vehicle 1A may have multiple different connectors 55, dedicated for the different types of loads.

The connector 55 of the vehicle 1 comprises a connection sensor 60 configured to detect when the cable is inserted or connected to the connector 55. In an aspect of the disclosure, the connection sensor 60 is a contact sensor. For example, a low voltage is supplied. When the metal contact(s) of the cable 62 electrical couple or mate with the connector 55, a circuit is completed, and a voltage is detected. The detection is reported to the SCU 35 via the CAN. The CAN line is shown in FIG. 1 as a thin line between the SCU 35 and connection sensor 60. However, in other aspects of the disclosure, a pressure or compression sensor may be used. In other aspects of the disclosure, the connection sensor 60 may be a photo-couple or photo diode detecting a change in light.

The connection cable 62 is shown in FIG. 1 as three thick lines, representing the three-phases of exportable AC power. As with the connector 55, a different cable 62 is used for different loads and power levels.

FIG. 1 also shows a filter 65 and transformer 70. The filter 65 and transformer 70 is also configured for different load types and power levels. Although, in FIG. 1, the filter 65 is shown external to the vehicle 1, in an aspect of the disclosure, the filter 65 may be included in the vehicle 1 and positioned between the switch 50 and the connector 55. Similarly, depending on the output AC power level, the transformer 70 may be internal to the vehicle 1. The size of the transformer 70 is related to the power level.

Additionally, while the filter 65 is shown as a single filter, three separate filters may be used, one for each output phase. The filter 65 removes at least high frequency switching noise. In an aspect of the disclosure, the filter may also be designed for the different output frequencies, such as 50 Hz or 60 Hz and different power levels.

The transformer 70 may be designed for different power requirements of the load. For example, a different transformer is used for a required power of 380 VAC, 400 VAC, 415 VAC and 480 VAC. The transformer 70 may be configured as a delta-delta, delta-wye, wye-wye, or wye-delta, based on load needs.

FIG. 1 illustrates the transformer 70 electrically coupled to a utility grid 75 (an example of a load). While in FIG. 1, a utility grid is provided as an example of the load, the vehicle 1 may export power to other types of loads and the load is not limited thereto.

Exporting power will typical occur when a vehicle is stopped and parked. In some aspects of the disclosure, the vehicle 1 may be turned off prior to an exportation request and insertion of the cable, e.g., key off signal.

In an aspect of the disclosure, when exporting power to a load is desired, an operator or user places the vehicle 1 into an exportation power mode. For example, an interface on the vehicle 1 (not shown), is operated by the user. The interface may include a switch.

In an aspect of the disclosure, the SCU 35 detects the user input and causes the switch 50 to open toward the propulsion motor 40 and close toward the connector 50, whereby the inverter 30 becomes electrically coupled to the connector 55.

In another aspect of the disclosure, even when the user switches the mode, the switch 50 may remained closed toward the propulsion motor 40 until the cable 62 is connected to the connector 55 and the connection sensor 60 detects the connection. In accordance with this aspect of the disclosure, the SCU 35 (processor therein) receives a signal from the connection sensor 60 and causes the switch to open toward the propulsion motor 40 and close toward the connector 55, whereby the inverter 30 becomes electrically coupled to the connector 55.

In another aspect of the disclosure, when the cable 62 is connected to the connector 55 (and detected by the connection sensor), the SCU 35 causes the engine 10 to automatically start and run at a specified speed. For example, the SCU 35 receives a connection signal from the connection sensor 60 and issues a command to the engine controller to fuel the engine and run at a specified speed.

The SCU 35 regulates power output from the ISG 15 and ESS 20 (via the PCS 27). For example, a balance of exportable power may be regulated based on a current fuel level and state of charge of the ESS 20. In an aspect of the disclosure, the ESS 20 reports its SOC to the SCU 35. Additionally, the engine controller may report the fuel level to the SCU 35.

In an aspect of the disclosure, a priority based control may be implemented. For example, priority may be given to fuel such that the ESS 20 is drained first. Alternatively, priority may be given to the SOC, such that the engine fuel is drained first. The priority may be selected by the operator via the interface.

In another aspect of the disclosure, an SOC threshold may be used. For example, the SCU 35 may cause power to be exported using only the ESS 20 when the SOC is above the SOC threshold and when the SOC goes below or equals the SOC threshold, power is exported via both the ESS 20 and the ISG 15. In an aspect of the disclosure, the SCU 35 causes the engine to automatically start and fuel when needed for exporting power (if OFF).

For example, the ISG 15 may output a first AC power level when the SOC is below the SOC threshold and the ISG 15 may output a second AC power level higher than the first AC power level, when the SOC of the ESS 20 is below another SOC threshold (where the another is lower than the SOC threshold). Thus, the SCE 35 maintains a required exported AC power level for the load (as long as possible).

In another example, the genset (ISG 15 and engine 10) may provide all power requirements for the load, e.g. utility grid 75, while the ESS 20 is not needed to provide power to the load. However, the ESS 20 may provide additional power should a transient power requirement, or a higher power requirement be necessitated by the load. Thereby, the SCU 35 may combine the variable speed generator set with an ESS 20 to maximize engine efficiency while maintaining power quality.

When the engine 10 is operating above the idle speed, the inverters 25/30 are configured such that the frequency of the output AC power is independent of the speed of the ISG 15.

While the three-phase AC power is being exported, the voltage and current of the three-phases is monitored as well as the voltage of the high voltage DC link. The SCU 35 regulates the three-phase AC power output from the inverter 30 based on the sensed signals. When an external cable is connected to Connector 55, Connection Sensor 60 sends a signal to the SCU which initiates a sequence to configure Inverter 30 and Switch 50 for supplying external power at a pre-configured voltage instead on internal propulsion power at a voltage compatible with the propulsion motor. When supplying external power, the SCU 35 regulates the AC output power from the inverter 30 based on the sensed current draw from the load 75 and sensed output voltage. A pre-configured voltage compatible with each load is applied and then then the SCU 35 regulates current to maintain this target voltage. Similarly, frequency of the AC power is pre-configured for connector 55. For example, the frequency may be 50 Hz or 60 Hz. Inverter switching frequencies for the various power levels is determined to enable optimal waveform construction.

FIG. 2 illustrates another example of a vehicle 1A for exporting power. Many of the components of the vehicle are the same and will not be described again in detail Like vehicle 1, vehicle 1A also has a series hybrid electric configuration. A difference between vehicle 1 and vehicle 1A is that vehicle 1A has multiple different (dedicated) inverters 1-N (30_{1-N}) for exportation of power. Each different inverter 30_{1-N} is individually operable and configured to provide a different AC output (and voltage). Each different inverter 30_{1-N} is connected to a different connector (respectively labeled as 55_{1-N}). As noted above, the connectors 55_{1-N} are different because of the different power levels. Each connector has a respective connection sensor 60.

Each different inverter 30_{1-N} provides a different exportable AC power to a different type of load, e.g., Load 1-N (labeled 75_{1-N}). For example, Load 1 may be a 480 VAC three phase load such as a electrical grid input to a building, Load 2 may be a 208 VAC three phase load and Load 3 may be a 240 VAC three phase load. For loads 2 and 3 a transformer may not be used. In other aspects of the disclosure, Load 1 may be 380 VAC three phase load, Load 2 400 VAC three phase load, and Load 3 may be 415 VAC three phase load. In these examples a transformer may be used. In an aspect of the disclosure, a transformer 70 is used to provide load voltages above 300VAC. In another aspect of the disclosure, Load 1 may be a 480 VAC three phase load, Load 2 may be a single phase 120 VAC and Load 3 may be a single phase 277 VAC. In this example, the single phase AC voltage is provided using delta-wye transformer(s).

Different cables (labeled 62_{1-N}), filters (labeled 65_{1-N}) and transformers (labeled 70_{1-N}) are respectively used. Like with FIG. 1, the filters 65_{1-N}, may be included in the vehicle 1A.

In FIG. 2, inverter 30A is directly coupled to the propulsion motor 40 without needing to go through a switch. The inverter 30A is labeled differently in FIG. 1 to highlight the different connection. However, the functionality of the inverter and structure are the same as in FIG. 1.

The SCU is similar to FIG. 1 except that the SCU 35A in FIG. 2 communicates with each inverter 30_{1-N} via CAN, the lines are shown in the figure as thin communication lines. The SCU 35A selectively controls the inverter 30_{1-N} based on a detected connection. The SCU 35A also does not need to cause a switch to open/close between the propulsion motor 40.

The SCU 35A selective controls the inverters 30_{1-N} to export power. For example, when a cable is respective connected to a specific connector (e.g., connector 55₁), it connection sensor 60 reports the connection to the SCU 35A. Upon receipt of the connection status change, the SCU 35A causes the inverter 1 30₁ to export power to load 1 75₁. The other inverters 2-N (e.g., 30_{2-N}) do not export any power. Additionally, inverter 30A does not supply any AC power to the propulsion motor 40. The supplying of export power to a load was described above and will not be described again in detail.

In another aspect of the disclosure, inverter 30A may be used as inverter 1 30₁. Thus, vehicle 1A may also have switch 50 and when cable 62₁ is inserted or connected into connector 55₁, the SCU 35A causes the switch 50 to open toward the propulsion motor 40 and close toward connector 55₁ in a similar manner as described above in FIG. 1.

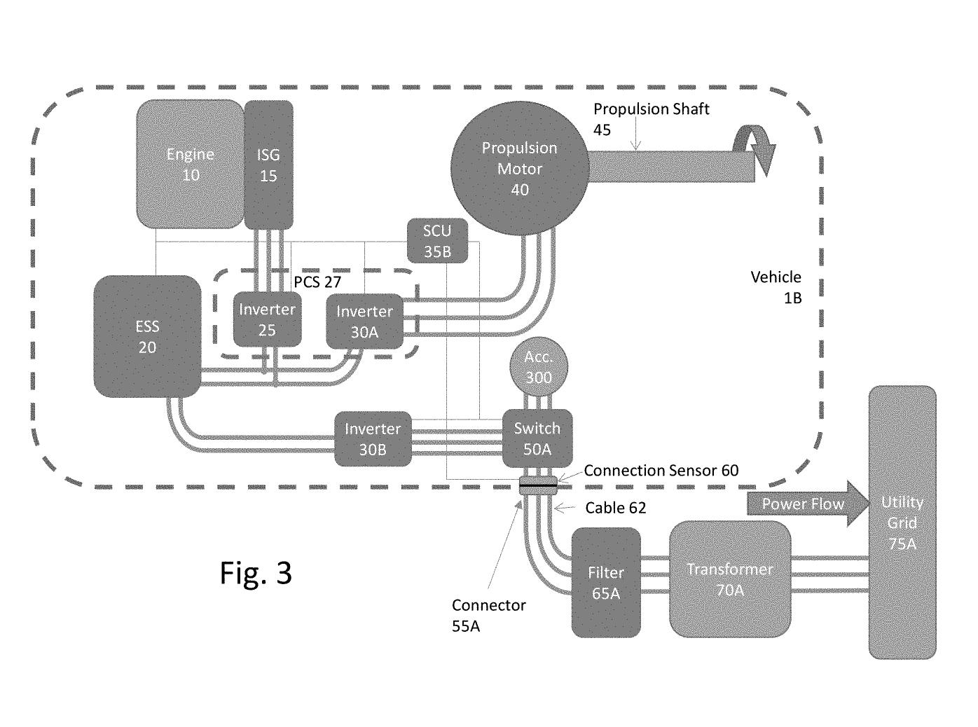

FIG. 3 illustrates another example of a vehicle 1B for exporting power. Many of the components of the vehicle are the same and will not be described again in detail. Like vehicles 1 and 1A, vehicle 1B also has a series hybrid electric configuration.

In FIG. 3, the vehicle 1B provides exportable power via an inverter 30B which is also used for powering an AC accessory 300 (e.g., AC motor). The inverter 30B is similar in structure as inverter 30. The labeling in FIG. 3 is changed to highlight the different connection(s).

For example, the AC accessories 300 may comprise air compressors, air condition compressors and power steering pumps. The AC accessories are not limited to the examples provided herein. The phrase “AC accessories” used herein also refers to the sub-systems required for the accessory to function.

The vehicle 1B may provide exportable power to a utility grid (e.g., example of load, labeled 75A) via a filter 65A and transformer 70A. Like in FIG. 1, a switch 50A is positioned between the inverter 30B and the AC accessory 300 and connector 55A. The switch 50A is actuated based on the detection of a connection of cable 62 detected by the connection sensor 60. The cable 62 may correspond to the type of load.

In accordance with aspects of the disclosure, the SCU 35B (processor therein) receives a signal from the connection sensor 60 and causes the switch 50A to open toward the propulsion motor 40 and close toward the connector 55A, whereby the inverter 30B becomes electrically coupled to the connector 55A. Like in FIG. 1, the SCU 35B may automatically start the engine by issuing a command to the engine controller via CAN. The SCU 35B thereafter causes the inverter 30B to provide exportable AC-power (three-phase) to the utility grid 75A via filter 65A and transformer 70A.

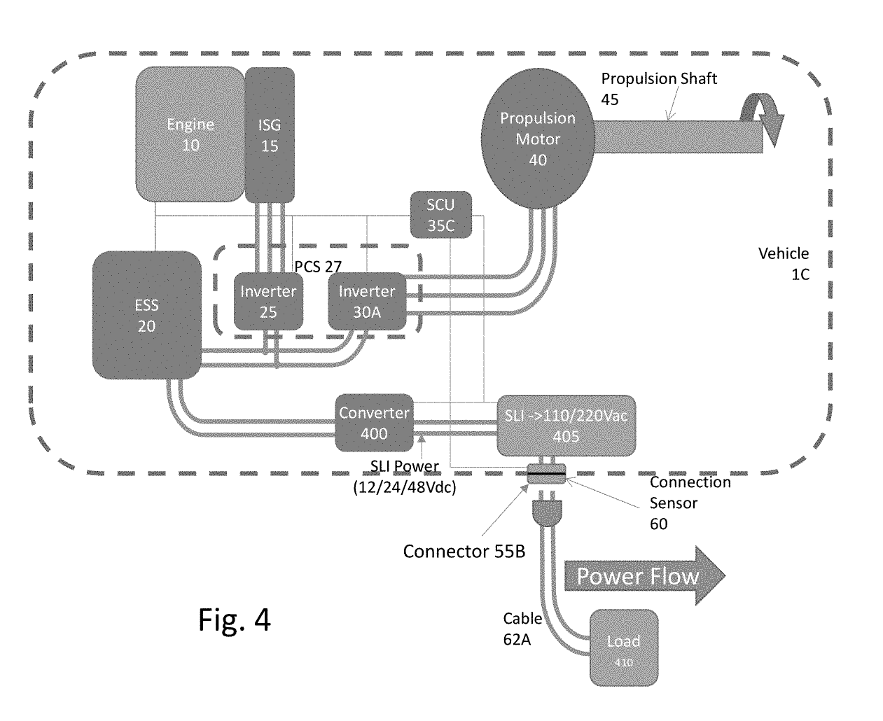

FIG. 4 illustrates another example of a vehicle 1C for exporting power. Many of the components of the vehicle are the same and will not be described again in detail Like vehicles 1, 1A and 1B, vehicle 1C also has a series hybrid electric configuration.

In vehicle 1C, power is exported from the vehicle 1C via a converter 400. Converter 400 is a high voltage to low voltage converter. In an aspect of the disclosure, the low voltage is equal to the SLI power voltage for the vehicle. This voltage may be 12 Vdc, 24 Vdc or 48 Vdc. A low voltage battery (not shown in FIG. 4) is also included in the vehicle 1C. The vehicle 1C further comprises a low voltage DC to an AC voltage converter (inverter) 405. This converter 405 outputs single-phase AC power. The single-phase AC power may be 110 Vac or 220 Vac. The low voltage DC power is shown in FIG. 4 using two thick lines connected to converters 400 and 405. The single-phase AC power output is also shown using two lines output from converter 405. SCU 35C communicates with the converters 400 and 405 via CAN which is shown in FIG. 4 using thin lines between the SCU 35C and respective converters. In other aspects of the disclosure, the SCU 35C uses discrete control signals such as an “enable” wire. For example, the SCU 35C may disable the converter 405 if an SLI battery (low voltage battery) is depleted to a specific level. In an aspect of the disclosure, the converter 405 would drive the output AC voltage to a pre-configured voltage level and regulate the current to maintain the output voltage are the pre-configured voltage level. Any filtering is performed by converter 405, as needed. A transformer is not needed.

As shown in FIG. 4, a cable 62A is coupleable to the connector 55B. The cable 62A is different from cable 62 (three-phase v. single phase). The cable 62A is coupled to the load 410.

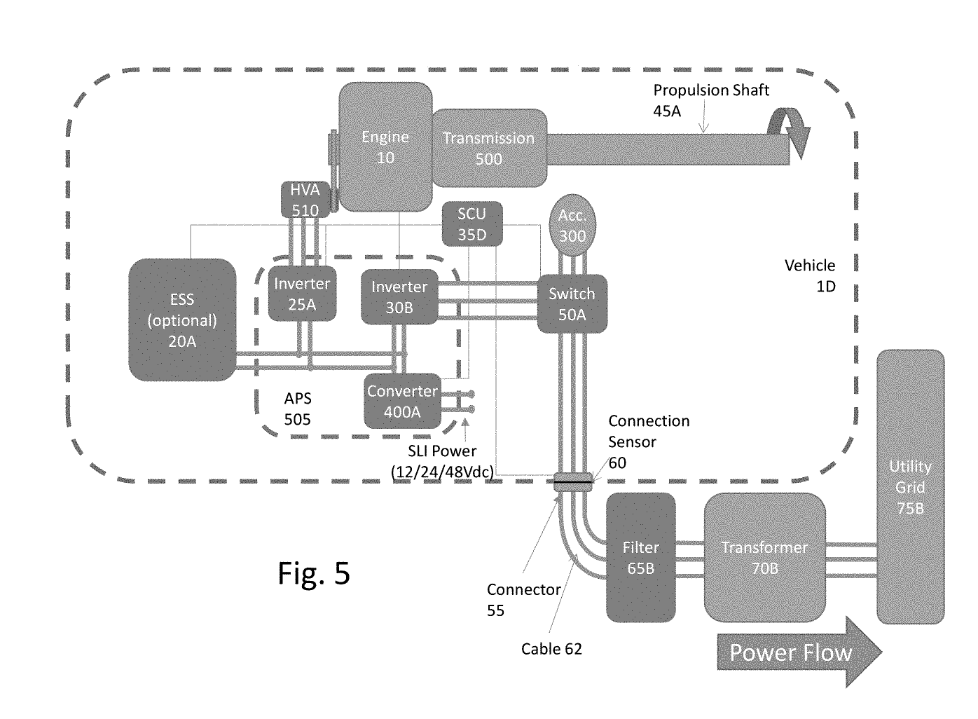

FIG. 5 illustrates another example of a vehicle 1D for exporting power. Many of the components of the vehicle are the same and will not be described again in detail. Unlike, vehicle 1-1C, vehicle 1D is not a hybrid vehicle, rather a conventional vehicle using the same components used to power the accessories for exportation. The generator is not directly connected to the engine crankshaft. The generator (e.g., high voltage alternator) is coupled to the front end of the engine via pulley/belt system. In another aspect of the disclosure, the HVA 510 may be mechanically coupled to the engine 10 via a front end power take-off device.

The vehicle 1D may optionally include an ESS 20A. When an ESS 20A is included, the generator may be an ISG, whereas, when the ESS 20A is not included, the generator cannot act as a starter.

The engine 10 is directly connected to the transmission 500 and propulsion shaft 45A.

The vehicle 1D comprises an accessory power system (APS) 505. The APS 505 is similar to the PCS 27 in that the APS includes two inverters 25A/25B. However, unlike the PCS in FIGS. 1-4, the APS 505 is separate from the propulsion system.

APS 505 provides for the power processing and conversion needed for supplying the required power to the DC accessories (not shown in the figure) and the AC accessories 300. The SCU 35D communicates with the APS 505 via CAN, which is shown in FIG. 5 as thin lines.

The APS 505 is electrically coupleable to DC accessories and AC accessories 300. As shown in FIG. 5, the inverter 30B is coupled to the accessory 300 via switch 50A.

The DC accessories (not shown in the figure) may comprise lighting, radio, fare box, power windows, doors, fans and power steering. The DC accessories are not limited to the examples provided herein.

Inverter 25A is electrically connected to the HVA 510 (an example of a generator). The inverter 25A (e.g., generator inverter), receives the three-phase AC power from the HVA 510. The inverter 25A outputs a high DC voltage to a high voltage DC link. The inverter 30B is coupled to the high voltage DC link. When included in the vehicle 1D, the ESS 20A is also coupled to the high voltage DC link. Also when included in the vehicle 1D, the SCU 35D also communicates with the ESS 20A via CAN.

The APS 505 also comprises converter 400A, which is a high voltage DC to low voltage DC converter similar to converter 400. FIG. 5 illustrates that the converter 400A output SLI power.

The APS inverter, when powered by a belt driven or PTO driven HVA 510, the output is limited by the HVA 510. For example, the APS inverter may provide 15 Kw. When an ESS 20A is included (and has sufficient charge), the APS inverter may provide higher power such as 30 Kw until the charge on the ESS 20A is depleted. When the charge is depleted, the available power which may be provided would drop to a limit of the HVA 510.

Similarly, the output of the converter 400 (see FIG. 4) is limited by the HVA 510. For example, the converter 400 may provide 14 Kw low voltage power (e.g., 28V).

Similar to with the series hybrid electric vehicles, exporting power will typical occur when a vehicle is stopped and parked. In some aspects of the disclosure, the vehicle 1D may be turned off prior to the exportation request and insertion of the cable, e.g., key off signal.

In an aspect of the disclosure, when exporting power to a load is desired, an operator or user places the vehicle 1D into an exportation power mode, e.g., via an interface.

In an aspect of the disclosure, the SCU 35D detects the user input and causes the switch 50A to open toward the accessory 300 and close toward the connector 55, whereby the inverter 30B becomes electrically coupled to the connector 55.

In another aspect of the disclosure, even when the user switches the mode, the switch 50A may remain closed toward the accessory 300 until the cable 62 is connected to the connector 55 and the connection sensor 60 detects the connection. In accordance with this aspect of the disclosure, the SCU 35D (processor therein) receives a signal from the connection sensor 60 and causes the switch to open toward the accessory 300 and close toward the connector 55, whereby the inverter 30B becomes electrically coupled to the connector 55.

In another aspect of the disclosure, when the cable 62 is connected to the connector 55 (and detected by the connection sensor), the SCU 35D causes the engine 10 to automatically start. For example, the SCU 35D receives the connected signal from the connection sensor 60 and issues a command to the engine controller to fuel the engine.

When no ESS 20A is included in the vehicle 1D, import power is solely based on power from the engine 10/HVA 510. Power may be exported to the utility grid (an example of a load, labeled in FIG. 5 as 75B) as long as the vehicle 1D has fuel via a filter 65B and transformer 70B. Like with the other vehicles 1-1C, the filter 65B and transformer 70B may be included in the vehicle 1D, depending on the size.

The SCU 35D controls the speed of the engine based on the required AC power for the load. While exporting AC power to the utility grid, the voltage and current on the three-phase AC power is detected. The SCU 35D controls the speed of the engine based on the voltage and current detected. For example, the speed of the engine may be increased when the HVA 510 has reached its current limit. The engine speed may also be adjusted to enable operation at an efficient operating point for fuel efficiency, e.g., determines and operates as a most efficient operating point.

When an ESS 20A is included in the vehicle 1D, the SCU 35D may provide the exported AC power from one or both the ESS 20A and/or the HVA 510/engine 10 (genset). In an aspect of the disclosure, the SCU 35D may prioritize providing the exported power from the ESS 20A. For example, since the available power exportable from the HVA 510 is less than a direct connection as described above, due to it being connected via pulley/belt, the available power may be higher from the ESS 20A.

In another aspect of the disclosure, the SCU 35D may use the control described with respect to FIG. 1 to provide exportable power to the utility grid 75B (e.g., load).

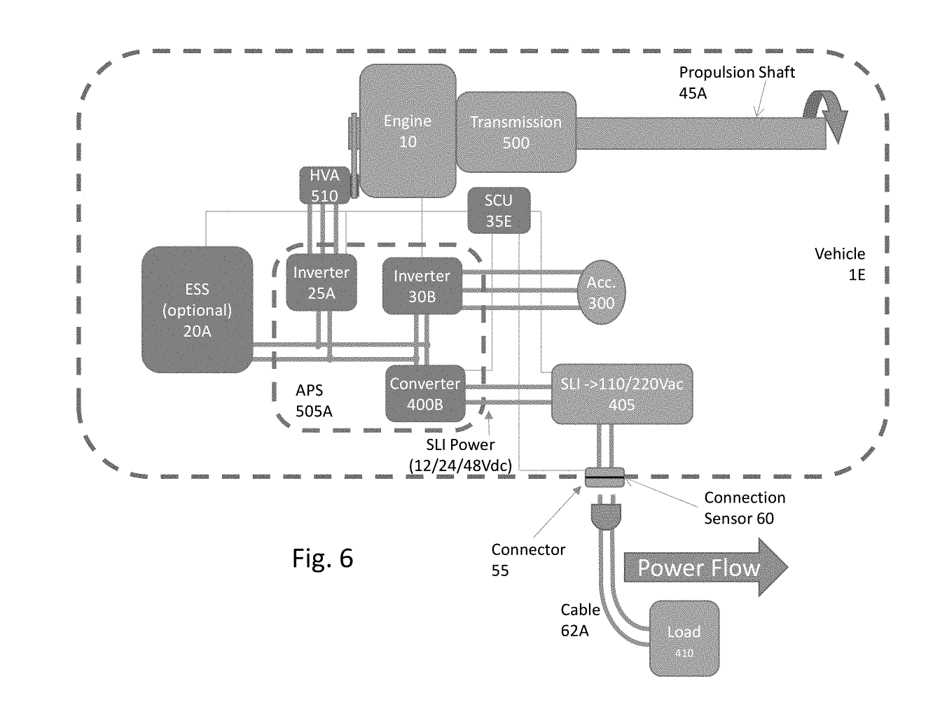

FIG. 6 illustrates another example of a vehicle 1E for exporting power. The vehicle 1E in FIG. 6 is similar to the vehicle 1D in FIG. 5 as it is a conventional vehicle. A difference in the vehicles is that in the vehicle 1E depicted in FIG. 6, power is exported via converter 400B (as opposed to inverter 30B). Switch 50A is not included in FIG. 6, e.g., switch between inverter and AC accessory.

In FIG. 6, the APS 505A has the converter 400B connected to a low voltage DC to an AC voltage converter (inverter) 405. While not shown in FIG. 6, if the converter 400B is also coupleable to a DC accessory, the vehicle 1E may also comprise a similar switch as switch 50A, selectively, coupling the DC output of the converter 400B to one of the DC accessory or the converter 405. In this aspect of the disclosure, since the output of the converter 400B is DC, one or more switching devices may be used on the positive and/or ground line. The converter 405 is similar to the converter shown in FIG. 4 and will not be described again in detail.

Like with exporting power described in FIG. 5, when the connection sensor 60 detects cable 62A, the SCU 35E causes the engine 10 to automatically start. For example, the SCU 35D receives the connection signal from the connection sensor 60 and issues a command to the engine controller to fuel the engine. When no ESS 20A is included in the vehicle 1E, import power is solely based on power from the engine 10/HVA 510. Power may be exported to the load as long as the vehicle 1E has fuel. As with FIG. 5, when an ESS 20A is included in the vehicle 1E, the SCU 35E may provide the exported AC power from one or both the ESS 20A and/or the HVA 510/engine 10 (genset). In an aspect of the disclosure, the SCU 35E may prioritize providing the exported power from the ESS 20A. For example, since the available power exportable from the HVA 510 is less due to it being connected via pulley/belt, the available power may be higher from the ESS 20A.

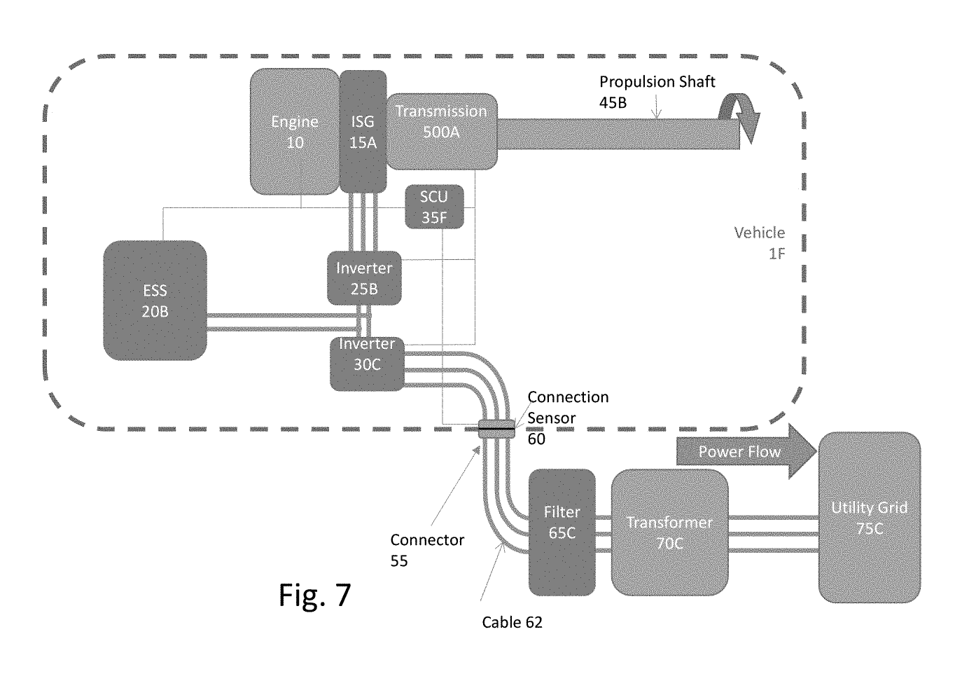

FIG. 7 illustrates another example of a vehicle 1F for exporting power. The vehicle 1F in FIG. 7 is a parallel hybrid electric vehicle. In FIG. 7, the ISG 15A is mechanically connected directly to the crankshaft of the engine 10. For example, the moveable shaft of the ISG 15A is coupled directly to the crankshaft of the engine. This shaft extends the length of the ISG and is also directly coupled to the transmission 500A for propulsion of the vehicle 1F. The transmission 500A is in turn mechanically coupled to the propulsion shaft 45B.

As described above, by mounted the ISG 15A directly on the crankshaft, it eliminates a need for a Power-take-off device. Additionally, a crankshaft mounted generator (such as ISG 15A) can be larger than a generator connected through an intermediary PTO, thereby enabling the generation of greater amounts of power to be exported. In the vehicle 1F depicted in FIG. 7, the same ISG 15A that normally supplies propulsion power for the vehicle 1F is used to supply power to an external load. In an aspect of the disclosure, the crankshaft mounted generator is capable of providing up to 110 Kw of 3 phase exportable power.

The vehicle 1F has an inverter 25B coupled to the IGS 15A and to the ESS 20B. However, for exporting power to an external load, an additional inverter 30C is added to the parallel configuration. This additional inverter 30C is coupled to both the ESS 20B and the inverter 25B. The additional inverter 30C receives a DC voltage from a DC link. The DC link is shown in FIG. 7 by two thick lines connected between the ESS 20B and inverters 25B and 30C. In an aspect of the disclosure, the ESS 20B provides a nominal voltage at or above 300 Vdc.

The SCU 35F communicates with the inverters 25B and 30C and ESS 20B and engine controller (not shown) via CAN (which is shown in FIG. 7 as thin lines).

The vehicle 1F may export three-phase AC power to a utility grid (e.g., example of a load, labeled as 75C) via filter 65C and transformer 70C. As described above, the filter 65C and transformer 70C may be included in the vehicle 1F.

Similar to the other configurations, exporting power will typical occur when a vehicle is stopped and parked. In some aspects of the disclosure, the vehicle 1F may be turned off prior to the exportation request and insertion of the cable, e.g., key off signal.

In an aspect of the disclosure, when exporting power to a load is desired, an operator or user places the vehicle 1F into an exportation power mode.

In an aspect of the disclosure, when the cable 62 is connected to the connector 55 (and detected by the connection sensor 60), the SCU 35F causes the engine 10 to automatically start and run at idle. For example, the SCU 35F receives the connection signal from the connection sensor 60 and issues a command to the engine controller to fuel the engine.

The SCU 35F regulates power output from the ISG 15A and ESS 20B. For example, a balance of exportable power may be regulated based on a current fuel level and state of charge of the ESS 20B. In an aspect of the disclosure, the ESS 20B reports its SOC to the SCU 35F. Additionally, the engine controller may report the fuel level to the SCU 35F.

In an aspect of the disclosure, a priority based control may be implemented. For example, priority may be given to fuel such that the ESS 20B is drained first. Alternatively, priority may be given to the SOC, such that the engine fuel is drained first. The priority may be selected by the operator via the interface.

In another aspect of the disclosure, an SOC threshold may be used. For example, the SCU 35F may cause power to be exported using only the ESS 20B when the SOC is above the SOC threshold and when the SOC goes below or equal to the SOC threshold, power is exported via both the ESS 20B and the ISG 15A. In an aspect of the disclosure, the SCU 35F causes the engine to automatically start and fuel when needed for exporting power (if shut off).

For example, the ISG 15A may output a first AC power level when the SOC is below the SOC threshold and the ISG 15A may output a second AC power level higher than the first AC power level, when the SOC of the ESS 20B is below another SOC threshold (where the another is lower than the SOC threshold). Thus, the SCU maintains a required exported AC power level for the load (as long as possible).

In another example, genset (ISG 15A and engine 10) may provide all power requirements for the load, e.g. utility grid 75C, while the ESS 20B is not needed to provide power to the load. However, the ESS 20B may provide additional power should a transient power requirement, or a higher power requirement be necessitated by the load. Thereby, the SCU 35F may combine the variable speed generator set with an ESS 20B to maximize engine efficiency while maintaining power quality.

While the description and figures show AC power being exported to an external load, in other aspects of the disclosure, the load, e.g., utlity grid, may be used to provide AC power to the vehicles and the ESSs charge based thereon. In accordance with this aspect of the disclosure, the operator instructs the SCUs to either export power or import power. For example, the operator may use an interface having a switch to control the direction of power flow.

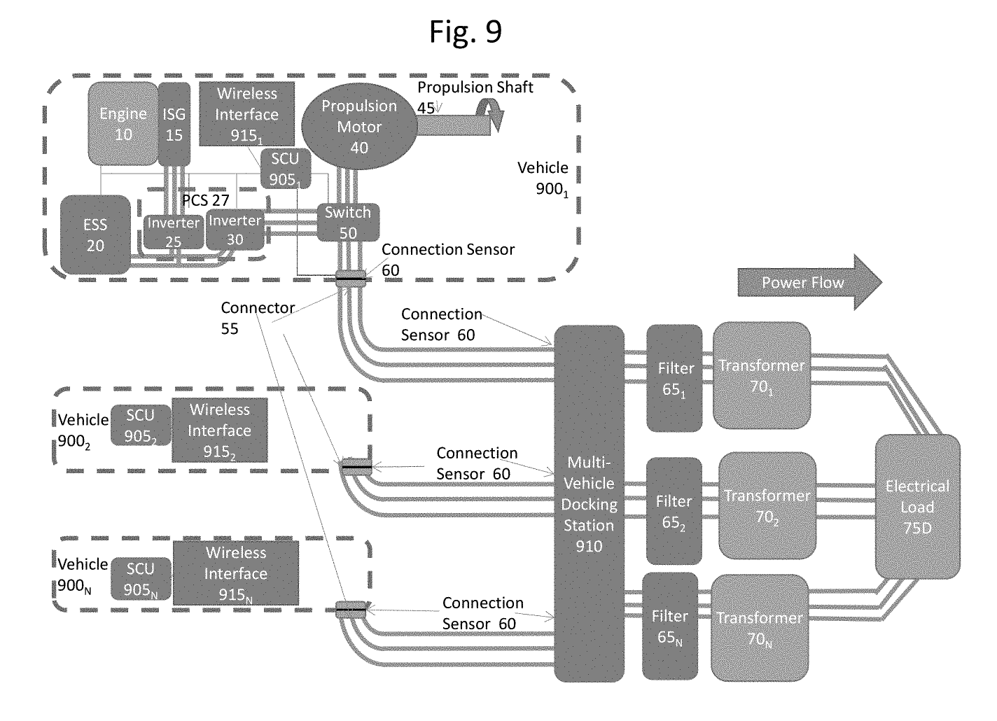

FIG. 9 illustrates multi-vehicle power system for exporting power to a load in accordance with aspects of the disclosure. Any of the above-described vehicles may be a part of a multi-vehicle power system. For purposes of the description in FIG. 9, a series hybrid configuration (similar to FIG. 1) is shown. In FIG. 9, vehicles 900₂ and 900_{N} are shown with the SCU, wireless interface, connector and connection sensor, to simplify the figure. However, these vehicles also may have the same components as vehicle 900₁.

Additionally, the following description equally applies to the other configurations and the multi-vehicle power system is not limited to the series hybrid configuration. Additionally, vehicles with different configurations may be simultaneously connected to the multi-vehicle docking station 910.

Multiple vehicles 900_{1-N} may power a single load, e.g., electrical load 75D, via a multi-vehicle docking station 910. The load 75D may be a stadium that requires a large amount of power than can be provided by a single vehicle by itself. For example, a stadium may be used in an emergency situation as an emergency shelter.

The vehicles 900_{1-N} are able to communicate with each other via wireless communication. Each vehicle 900_{1-N} has a wireless interface 915. The wireless interface 915 is shown in FIG. 9 as a separate element for purposes of the description. In an aspect of the disclosure, the wireless interface may be included in the SCU 905.

In an aspect of the disclosure, each wireless interface 915_{1-N} may be configured for communication using a WI-FI communication protocol. Other communication protocols may also be used. The provided AC power from the vehicles 900_{1-N} is respectively filtered by filters 65_{1-N} and supplied to a respective transformer 70_{1-N} (and subsequently to the load 75D). FIG. 9 depicts N separate three-phase connections to the electrical load 75D (from the N respective transformers). However, in other aspects of the disclosure, the N-outputs may be spliced together prior to connection to the electrical load 75D. For example, for the three-phases, all N-first phases may be spliced together, all N-second phases may be spliced together, and all N-third phases may be spliced together. Therefore, a single-three phase cable may then be connection to the electrical load 75D.

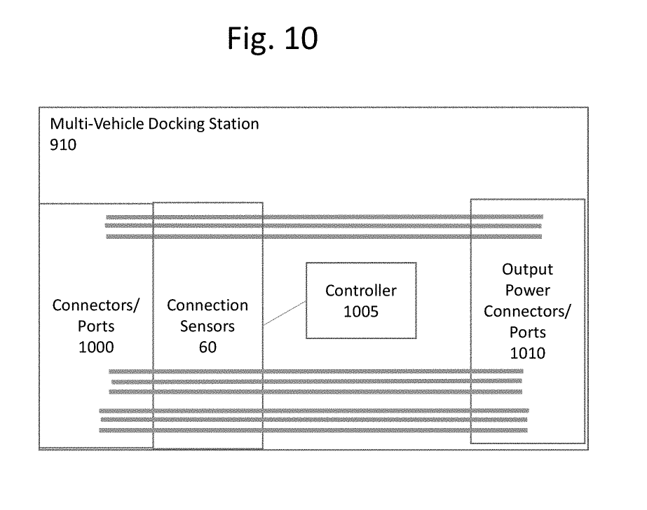

FIG. 10 illustrates a block diagram of the multi-vehicle docking station 910 in accordance with aspects of the disclosure. The multi-vehicle docking station 910 comprises connectors/ports 1000, connection sensors 60, a controller and output power connectors/portions 1010. The number of connection sensors 60 equals the number of connectors/ports 1000. A similar connection sensor as described above may be used. The connectors/ports 1000 are also similar to described above. There are more than one connectors/ports 1000. The number of output power connectors/ports 1010 also equals the number of connectors/ports 1000. The output power connectors/ports 1010 is electrically connected to the connectors/ports 1000. The connections are shown with three thick lines for each connection. While FIG. 10 shows three connections, the number of ports may be more than three. Three has been shown only for the purpose of description.

The controller 1005 may be a microcontroller or microprocessor or any other processing hardware such as a CPU or GPU. The memory may be separate from the processor (as or integrated in the same). For example, the microcontroller or microprocessor includes at least one data storage device, such as, but not limited to, RAM, ROM and persistent storage. In an aspect of the disclosure, the processor may be configured to execute one or more programs stored in a computer readable storage device. The computer readable storage device can be RAM, persistent storage or removable storage. A storage device is any piece of hardware that is capable of storing information, such as, for example without limitation, data, programs, instructions, program code, and/or other suitable information, either on a temporary basis and/or a permanent basis.

In an aspect of the disclosure, the multi-vehicle docking station 910 may also have a wireless communication interface. The controller 1005 receives a signal from a respective connection sensor when a cable is connected to the connectors/ports. In an aspect of the disclosure, when the controller 1005 receives the signal, the controller 1005 transmits a signal to a vehicle indicating a connection. The transmission may be a broadcast.

When more than one vehicle is connected to the multi-vehicle docking station 910, which vehicle(s) supply power may be selected, e.g., prioritized. In an aspect of the disclosure, the selection (supplying order) may be determined based on a remaining power capacity in each vehicle and/or fuel level in each vehicle.

Each vehicle also has a connection sensor 60 as described above. When the connection sensor 60 detects a cable 62 connected to a respective connector, the SCU 905 receives a signal indicating the same. When the signal is received, the SCU 905 determines the current fuel level and total remaining capacity and transmits the information to other vehicles. The total remaining power capacity (kilowatt-hours) is the sum of the remaining power capacity of the genset and the remaining power capacity of the ESS 20. The transmission may be a broadcast. In another aspect of the disclosure, the transmission may be a multi-cast. For example, vehicles within the area may discover each other via a periodic beacon. Once discovered, the SCU 905 may create the multi-case message. The current fuel level and remaining power capacity may be periodically transmitted.

The message containing the current fuel level and the remaining power capacity may also include a timestamp. In an aspect of the disclosure, the fuel level is in gallons. In an aspect of the disclosure, the initial message may also include the total capacity of the ESS 20.

Further, in an aspect of the disclosure, the initial message may also include the maximum export capability of the vehicle and configuration of the vehicle.

In an aspect of the disclosure, one of the vehicles (e.g., 900₁) is selected as a master. In an aspect of the disclosure, a first vehicle connected to the multi-vehicle docking station 910 is determined as the master. For example, the signal transmitted from the multi-vehicle docking station 910 indicating connection may include a timestamp. In other aspects of the disclosure, instead of using a timestamp, the signal transmitted from the multi-vehicle docking station 910 includes the status of each connection sensor 60. Thus, when the status indicates only one vehicle is connected, the vehicle knows it is first.

In another aspect of the disclosure, the master may be selected based on the remaining power capacity and fuel level for each vehicle 900_{1-N} connected to the multi-vehicle docking station. For example, a vehicle with the highest fuel level may be the first master selected. In other aspects of the disclosure, the highest remaining power capacity may be selected as the first master.

In another aspect of the disclosure, the master may be selected based on the type of configuration the vehicle has. For example, a series hybrid electric vehicle, which is capable of providing more power than a parallel hybrid electric vehicle, may be selected first (as opposed to the parallel). In another aspect of the disclosure, the multi-vehicle docking station 910 determines the master. In other aspects of the disclosure, the multi-vehicle docking station 910 is the master. When the multi-vehicle docking station is the master, the master does not change, whereas when a vehicle is the master, the master may change.

The vehicle that is selected as the master (e.g., 900₁), maintains a master load supply file in memory (not shown). All of the vehicles have the capability to be a master. For purposes of this description vehicle 900₁ is the first master. Specifically, the SCU 905₁ in the master stores the received total remaining power capacity and fuel level from the other vehicles (e.g., 900_{2-N}) as well as its own remaining power capacity and fuel level in the supply file. When the message from the other vehicles also includes the timestamp, the time is also stored in the supply file.

The master determines which vehicles 900_{1-N} supplies power to the load 75D. In an aspect of the disclosure, the master (e.g., 900₁), using the SCU 905₁ may select the vehicle(s) for providing export power based on the received remaining power capacities and fuel levels for the vehicles 900_{1-N} connected to the multi-vehicle docking station 910.

For example, a fuel threshold may be used. Any vehicle(s) having a fuel level above the threshold may be allowed to provide power to the load 75D (e.g., selected). The SCU 905₁ compares the received fuel from each vehicle 900_{1-N} connected to the multi-vehicle docking station 910 to the respective threshold. When a vehicle has the fuel level above the respective threshold, the SCU 905₁, transmits an enabling signal to the vehicle.

In an aspect of the disclosure, each vehicle 900_{1-N} determines its own total remaining power capacity (remaining capacity). As noted above, the remaining power capacity is the sum of the remaining ESS power capacity and the remaining engine and generator (genset) power capacity available through the use of fuel. The remaining ESS power capacity is evaluated using the SOC and total ESS capacity (nominal). The remaining genset power capacity is determined by evaluating the remaining fuel level, the fueling rate and actual engine power being provided. The remaining power capacity is also based on a system efficiency factor. The system efficiency factor is specific to a type of configuration. In an aspect of the disclosure, a look-up table may have the efficiency factor(s) indexed by the type of configuration.

In other aspects of the disclosure, instead of calculating the remaining power capacities, each vehicle has a look-up table(s) preset with remaining power capacities of the vehicle, indexed by current SOC and remaining fuel level. One look-up table may be used for the genset and remaining fuel level and another look-up table may be used for the ESS 20 and the SOC.

In other aspects of the disclosure, instead of each vehicle determining the remaining power capacity, the master determines the remaining power capacity for each vehicle 900_{1-N} connected to the multi-vehicle docking station 910.

Vehicle(s) capable of supplying power longer may be selected by the master to provide power.

In an aspect of the disclosure, the master (e.g., 900₁), using SCU (e.g., 905₁) compares the remaining power capacities from each vehicle with each other and selects the vehicle(s) with the highest remaining power capacities to provide power. For example, the master may select M number of vehicles with the highest remaining power capacities. In other aspects of the disclosure, the master (e.g., 900₁), using SCU (e.g., 905₁) compares the remaining power capacities from each vehicle with a power capacity threshold and selects the vehicle(s) with the remaining power capacities higher than the threshold.

In other aspects of the disclosure, vehicles waiting to dock also broadcast its respective remaining capacities, e.g., genset and ESS. The master (e.g., 900₁), using SCU (e.g., 905₁) compares the remaining power capacities from vehicles that are waiting with remaining power capacities of vehicles 900_{1-N} already connected to the multi-vehicle docking station 910. When a vehicle waiting has a high remaining power capacity than one of the vehicles connected to the multi-vehicle docking station 910, the master (e.g., 900₁), using SCU (e.g., 905₁) transmits a request to undock to the vehicle with less remaining power capacity and a request to the waiting vehicle with more remaining power capacity to dock. In an aspect of the disclosure, the change in vehicles prioritizes a lower fuel level, e.g., less remaining power capacity for the genset, whereby the undocked vehicle may obtain additional fuel.

In an aspect of the disclosure, the change is based on a threshold, where if the waiting vehicles power capacity is more than X% greater, the vehicles are changed.

In other aspects of the disclosure, instead of having a vehicle undock when the vehicles capacity is lower than a waiting vehicle, the master compares the docked vehicle's capacity with a lower threshold. If the docked vehicle's capacity is less than the lower threshold, the vehicle is requested to undock (in favor of the waiting vehicle). If the docked vehicle's capacity is greater than or equal to the lower threshold, the vehicle remains docked.

In other aspects of the disclosure, the selection of vehicles that provide export power may also be determined based on type of configuration of the vehicle. For example, priority for providing power may be given to a series hybrid electric vehicle over a parallel hybrid electric vehicle. Both may have priority over a vehicle where the generator (e.g., HVA) is coupled to the engine via a belt system or PTO. Additionally, priority may also be based on which inverter or converter is being used for providing power. For example, an inverter also providing propulsion power may have a higher priority than as inverter supplying only accessory power. When the type of configuration of the vehicle is used, the initial message from a vehicle further includes information indicating the type.

The master must give permission for a vehicle to undock. Therefore, when a docked vehicle needs to undock, the vehicle transmits a request to the master.

During the supplying of power to a load 75D, the vehicle that is the master may change. For example, a vehicles remaining capacity and/or fuel level may be used to change the master. In an aspect of the disclosure, the master (e.g., 900₁), using the SCU 905₁, monitors its own SOC, fuel level and determines the remaining power capacity (genset and ESS). When the fuel level and/or remaining power capacity goes below a respective level, the vehicle will no longer serve as the master. The SCU (e.g., 905₁) transmits a signal to the other vehicles (e.g., 900_{2-N}), indicating that the vehicle (e.g., 900₁) is no longer the master. A new master is selected using any of the above-identified criteria. In an aspect of the disclosure, the current master selects the new master using the information from the supply list. The signal transmitted by the SCU (e.g., 905₁) indicates the new master and also includes the master load supply file (most updated version thereof). The above process is repeated each time a master is changed.

Even when no vehicle is waiting to dock to the multi-vehicle docking station 910, the master may instruct a vehicle to undock. For example, the master may use a capacity threshold to determine whether a vehicle 900_{1-N} should undock. The capacity threshold may or may not be the same as the lower threshold. The SCU (e.g., 905₁) compares the determined remaining power capacity with the capacity threshold. When the remaining power capacity for a vehicle is lower than the capacity threshold (for the vehicle type), the SCU (e.g., 905₁) transmits a warning to the vehicle. In an aspect of the disclosure, the warning also includes a permission to undock the vehicle from the multi-vehicle docking station.

In other aspects of the disclosure, each vehicle 900 monitors its own remaining capacity and fuel level. The SCU 905_{1-N} in each vehicle 9001-N compares the remaining power capacity and/or fuel level with a respective threshold. When the remaining power capacity and/or fuel level is below the respective threshold, the SCU 905 of that vehicle transmits a request to undock the vehicle from the multi-vehicle docking station 910. The request has the determined remaining power capacity and/or fuel level. The master (e.g., 900₁), using the SCU e.g., 905₁ (and wireless interface) transmits permission to unlock to the vehicle that sent the request. The master also updates the master load supply file with the received information.

In addition to determining which vehicles are allowed to export power to an electrical load 75D, the master (e.g., 900₁), using the SCU e.g., 905₁ may also regulate the amount of power provided by each selected vehicle. In an aspect of the disclosure, the vehicles also periodically broadcast the amount of power being exported to the load 75D. In an aspect of the disclosure, the master (e.g., 900₁), using the SCU e.g., 905₁, balances the amount of power being exported to be equal (for each vehicle exporting power). In another aspect of the disclosure, the master (e.g., 900₁), using the SCU e.g., 905₁ regulates the amount of power being exported based on the remaining fuel level and remaining power capacities. The master (e.g., 900₁), using the SCU e.g., 905₁ (and wireless interface) transmits an instruction to each vehicle having allowed power level for exportation.

The functionality described herein for the SCUs is executed by a processor in the same. As used herein, in addition to described above, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by the SCUs, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure

What is claimed is:

1. A power system for a vehicle comprising:
a first inverter coupled to a generator, where the generator is mechanically coupleable directly to a crankshaft of an engine, the first inverter, when the generator is coupled directly to the crankshaft of the engine, is configured to receive three-phase AC power from the generator when the engine is ON and provide DC power for a DC link;
a second inverter coupled to the DC link and configured to receive the DC power from the first inverter and provide three-phase AC power to a first power path and a second power path;
a switch configured to switch the provided three-phase AC power from the second inverter to one of the first power path and the second power path, the second power path supplying power to an external load; and
a processor configured to control the switch and cause the three-phase AC power to be supplied to the external load or to the first power path at determined frequency and determined voltage, when supplying power to the external load, the determined frequency and the determined voltage meeting power requirements for the external load.

2. The power system for a vehicle according to claim 1, further comprising a connection interface electrically coupled to the second power path, the connection interface having a sensor configured to detect a cable connected thereto, the sensor being in electrical communication with the processor, wherein, when the sensor detects the cable being connected to the connection interface, the sensor transmits a signal indicating a connection to the processor and the processor controls the switch to enable the three-phase AC power to be provided to the second power path.

3. The power system for a vehicle according to claim 1, wherein the first power path is coupled to an AC accessory.

4. The power system for a vehicle according to claim 2, wherein the vehicle is a series hybrid electric vehicle, and wherein the first power path is coupled to an AC propulsion motor.

5. The power system for a vehicle according to claim 4, further comprising an energy storage device configured to provide DC power to the DC link and wherein the processor is configured to control the three-phase AC power received from the generator based on a state of charge (SOC) in the energy storage device, fuel for the engine and the power requirements of the external load.

6. The power system for a vehicle according to claim 5, wherein when the SOC of the energy storage device is above a preset threshold, power provided by the second inverter is supply from the energy storage device and the engine is OFF.

7. The power system for a vehicle according to claim 5, wherein when the SOC of the energy storage device is below or at the preset threshold, the processor causes the engine to start and receive fuel, wherein power to the external load is supplied by at least the generator.

8. The power system for a vehicle according to claim 1, wherein when the engine is running at a speed above idle, a frequency of the provided three-phase AC power is independent of the speed of the engine and the generator.

9. The power system for a vehicle according to claim 1, further comprising at least one current sensor configured to sense a current drawn by the external load, and at least one voltage sensor, wherein the processor is configured to control the three-phase AC power provided by the second inverter based on the sensed current and the sensed voltage.

10. The power system for a vehicle according to claim 2, wherein the cable is coupleable to the external load via a filter and a transformer.

11. The power system for a vehicle according to claim 2, further comprises a filter along the second power path coupled between the switch and the connection interface.

12. The power system for a vehicle according to claim 2, wherein when the processor receives the signal indicating the connection of the cable to the connection interface, the processor is configured to cause the engine to automatically start.

13. The power system for a vehicle according to claim 1, further comprising:
a plurality of second inverters, the plurality of second inverters including the second inverter, each second inverter being electrically coupled to the DC link and configured to receive the DC power from the first inverter and provide the three-phase AC power, wherein the power provided by each of the plurality of second inverters is different; and
a plurality of connection interfaces electrically coupled to the second power path, each connection interface having a sensor configured to detect a cable connected thereto, the sensor being in electrical communication with the processor, wherein, when the sensor detects the cable being connected to a respective connection interface, the sensor transmits a signal indicating a connection to the processor and the processor is configured to control a corresponding one of the plurality of second inverters to provide the three-phase AC power to the second power path.

14. The power system for a vehicle according to claim 13, wherein when the corresponding one of the plurality of second inverter is the second inverter, the processor is configured to control the switch to switch between the first power path and the second power path.

15. The power system for a vehicle according to claim 5, wherein the power system is configured to provide 230 kW of power.

16. A power system for a vehicle comprising:
a first inverter coupled to a generator, where the generator is mechanically coupleable to an engine, the first inverter, when the generator is coupled to the engine, is configured to receive three-phase AC power from the generator when the engine is ON and provide DC power for a DC link;
a DC-DC converter coupled to the DC link and configured to receive the DC power from the first inverter and converter the received DC power into another DC power level, where the DC-DC converter is coupleable to another power converter, the another power converter configured to provide single-phase AC power to an external load via a cable connected to a connection interface.

17. A power system for a parallel hybrid electric vehicle comprising:
a first inverter coupled to a generator, where the generator is mechanically coupleable directly to a crankshaft of an engine, the first inverter, when the generator is coupled directly to the crankshaft of the engine, is configured to receive three-phase AC power from the generator when the engine is ON and provide DC power for a DC link;
an energy storage device configured to provide DC power to the DC link;
a second inverter coupled to the DC link and the energy storage device and configured to receive the DC power from the DC link and provide three-phase AC power to an external load; and
a processor configured to cause the three-phase AC power to be supplied to the external load when the external load is connected to a connection interface via a cable.

18. The power system for a vehicle according to claim 17, wherein the power system is configured to provide 110 kW of power.

19. A power system comprising:
a plurality of vehicles; and
a vehicle docking station comprising:
a plurality of docking ports;
a wireless communication interface;
a processor; and
a connection sensor, wherein the vehicle docking station is coupleable to an external load,
wherein each vehicle comprises:
a power processor;
a wireless communication interface; and
a connection interface, the connection interface being electrical coupleable to the vehicle docking station via a cable, the cable being coupleable to a respective docking port,
wherein when the vehicle is electrical coupled to the vehicle docking station via the cable in the docking port, the sensor in the vehicle docking station detects the coupling and transmits a signal indicating the coupling to the processor,
wherein when a plurality of vehicles are coupled to the vehicle docking station, a power processor of one of the vehicles is determined as a master processor, the master processor having a master load supply file, the master load supply file having a remaining power capacity of each vehicle coupled to the vehicle docking station and a fuel level in each vehicle coupled to the vehicle docking station, each vehicle wirelessly transmits the remaining power capacity and fuel level to the master processor, and
wherein when one or more vehicles are coupled to the vehicle docking station and the vehicle docking station is coupled to the external load, power is suppliable from the one or more vehicles vehicle to the external load based on a respective remaining power capacity and a respective fuel level.

20. The power system of claim 19, wherein when the fuel level of a vehicle is below a predetermined value, the power processor for the vehicle wirelessly transmits a signal to the master processor, in response to receipt of the signal, the master processor updates the master load supply file and transmits a permission to undock to the vehicle from the vehicle docking station.

21. The power system of claim 19, wherein when the fuel level of the vehicle determined as the master processor is below a predetermined value, the master processor wirelessly transmits a signal to each of the plurality of vehicles and another of the plurality of vehicles becomes the master processor.

22. The power system of claim 21, wherein another of the plurality of vehicles is selected by the master processor based on the remaining power capacity and the fuel level, respectively in each of the plurality of vehicles coupled to the vehicle docking station.

23. The power system of claim 22, wherein the master processor compares the remaining power capacity with a preset threshold; and wirelessly transmits a warning to a respective vehicle when the remaining power capacity for the vehicle is lower than the preset threshold.

24. The power system of claim 19, wherein the processor in the vehicle docking station determines an initial master processor.

25. The power system of claim 19, wherein each vehicle comprises:
a first inverter coupled to a generator, where the generator is mechanically coupleable directly to a crankshaft of an engine, the first inverter, when the generator is coupled directly to the crankshaft of the engine, is configured to receive three-phase AC power from the generator when the engine is ON and provide DC power for a DC link;
an energy storage device configured to provide DC power to the DC link;
a second inverter coupled to the DC link and the energy storage device configured to receive the DC power from the DC link and provide three-phase AC power to the external load at a determined frequency and a determined voltage, when supplying power to the external load, the determined frequency and the determined voltage meeting power requirements for the external load.

26. The power system of claim 19, wherein the master processor further receives a remaining power capacity of each vehicle waiting to couple to the vehicle docking station and a fuel level in each vehicle waiting couple to the vehicle docking station.

27. A power system for a vehicle comprising:
a first inverter coupled to a generator, where the generator is mechanically coupleable to an engine, the first inverter, when the generator is coupled to the engine, is configured to receive three-phase AC power from the generator when the engine is ON and provide DC power for a DC link;
a second inverter coupled to the DC link and configured to receive the DC power from the first inverter and provide three-phase AC power to a first power path and a second power path;
a switch configured to switch the provided three-phase AC power from the second inverter to one of the first power path and the second power path, the first power path supplying power to an AC accessory and the second power path supplying power to an external load; and
a processor configured to control the switch and cause the three-phase AC power to be supplied to the external load or to the AC accessory at determined frequency and determined voltage, when supplying power to the external load, the determined frequency and the determined voltage meeting power requirements for the external load.
